(19) United States
(12) Patent Application Publication
(10) Pub. No.: US 2025/0269304 A1
(43) Pub. Date: Aug. 28, 2025

(54) NON-POWERED WATER SUPPLY SYSTEM

(71) Applicant: AMOGREENTECH CO., LTD., Gimpo-si (KR)

(72) Inventors: Jin LEE, Gimpo-si (KR); Eun Su YU, Anyang-si (KR); Yong Dae KIM, Cheongju-si (KR)

(73) Assignee: AMOGREENTECH CO., LTD., Gimpo-si (KR)

(21) Appl. No.: 18/866,093

(22) PCT Filed: Apr. 12, 2023
(86) PCT No.: PCT/KR2023/004967

§ 371 Date: Nov. 15, 2024

(30) Foreign Application Priority Data
May 19, 2022 (KR) 10-2022-0061409

(51) Int. Cl. B01D 29/52; B01D 29/05; C02F 1/00; C02F 1/50; C02F 1/68; C02F 103/00

(52) U.S. Cl. CPC B01D 29/52; B01D 29/05; C02F 1/004; C02F 1/50; C02F 1/685; B01D 2201/10; B01D 2201/26; C02F 2103/001; C02F 2303/04

(57) ABSTRACT

A non-powered water supply system includes: a raw water supply unit for supplying raw water; a filtration unit including a filtration tank for storing a certain amount of the raw water supplied from the raw water supply unit, a filter assembly installed inside the filtration tank to produce filtered water by filtering out foreign substances from the raw water, and a base frame fixed to the bottom surface of the filtration tank so that the filter assembly can be installed at a certain height above the bottom surface of the filtration tank; and a filtered water storage tank for temporarily storing the filtered water produced in the filtration tank.

### CROSS REFERENCE TO THE RELATED APPLICATIONS

This application is the national phase entry of International Application No. PCT/KR2023/004967, filed on Apr. 12, 2023, which is based upon and claims priority to Korean Patent Application No. 10-2022-0061409, filed on May 19, 2022, the entire contents of which are incorporated herein by reference.

### TECHNICAL FIELD

The present invention relates to a non-powered water supply system.

### BACKGROUND

A clean and safe supply of water is essential for human health and survival. Accordingly, in densely populated urban areas, a large-scale water purification system is established to filter various foreign substances contained in raw water, and then clean water is supplied to a place of use (for example, a consumer).

However, in islands and mountainous areas, it is difficult to establish a large-scale water treatment system such as an urban area due to limitations in installation space or cost problems caused by small water supply households.

Accordingly, in islands and mountainous areas, small-scale water supply systems are established to obtain purified water from surface water such as rainwater, valley water, or the like and water is supplied to a place of use.

However, unlike large-scale water supply systems, small-scale water supply systems remove foreign substances from raw water through slow filtration using sand or activated carbon in small water purification plants and then supply filtered water to a place of use.

Accordingly, during rainy seasons or floods when there is a lot of precipitation, high-turbidity raw water flows into a small water purification plant, so it is difficult to secure the stability of water quality in a small water supply system.

### SUMMARY

### Technical Problem

The present invention has been devised in view of the above problems, and is directed to providing a non-powered water supply system capable of securing stability of water quality even in a small-scale water supply facility.

### Technical Solution

In order to achieve the above objects, the present invention provides a non-powered water supply system, including: a raw water supply unit configured to supply raw water; a filtration unit including a filtration tank for storing a certain amount of the raw water supplied from the raw water supply unit, a filter assembly installed inside the filtration tank to produce filtered water by filtering out foreign substances from the raw water, and a base frame fixed to the bottom surface of the filtration tank so that the filter assembly can be installed at a certain height above the bottom surface of the filtration tank; and a filtered water storage tank for temporarily storing the filtered water produced in the filtration tank.

In addition, the raw water may be valley water, or rainwater stored in a rainwater storage tank.

In addition, the raw water supply unit may be located at a higher altitude than the filtration unit so that the raw water may be supplied to the filtration tank by gravity.

[11], In addition, the non-powered water supply system may further include a chemical supply unit for disinfecting raw water supplied to the filtration tank or for disinfecting filtered water produced in the filtration tank.

In addition, the filter assembly may include a plurality of filter modules each including a plate-shaped filtration member having a predetermined area; a fastening bar configured to fasten the plurality of filter modules together so that the filtration members of each of the two adjacent filter modules face each other and maintain a state spaced apart at a predetermined interval; and a common water receiving member connected to a receiving port provided in each of the plurality of filter modules to integrate filtered water produced by each of the plurality of filter modules, and the filter assembly may be coupled to the base frame via a spacing member so that the plurality of filter modules integrated through the fastening bar may be installed at a predetermined height spaced apart from the base frame.

In addition, the base frame may include a plurality of first frames having a predetermined length and spaced apart from each other, and a second frame configured to fasten mutually at least two first frames of the plurality of first frames, and the filter assembly may be detachably coupled to the second frame via the spacing member.

[14] In addition, the non-powered water supply system may further include a plurality of filter assemblies detachably coupled to the base frame and an integrated water receiving member connected to the common water receiving member provided in each of the plurality of filter assemblies to integrate filtered water produced in each of the plurality of filter assemblies, and the integrated water receiving member may be coupled to the base frame to be located at a lower position than the common water receiving member.

In addition, the filter assembly may further include a towing wire with both ends fixed respectively to two fastening bars for integrating the plurality of filter modules.

### ADVANTAGEOUS EFFECT

According to the present invention, even if the structure and process of the existing small-scale water supply system are not changed, operation management is easy, economic feasibility is excellent, and impurities can be completely removed, thereby preventing water quality accidents that may occur in a place of use.

In addition, according to the present invention, it is possible to filter foreign substances using the pressure difference due to the position head without using separate power, thereby reducing production costs by eliminating the need for separate auxiliary facilities to press the raw water.

### BRIEF DESCRIPTION OF THE DRAWINGS

FIG. 1 is a schematic block diagram of a non-powered water supply system according to one embodiment of the present invention.

FIG. 2 is a view schematically illustrating a state in which a filter assembly is installed inside a filtration tank in a filtration unit of a non-powered water supply system according to one embodiment of the present invention.

FIG. 3 is a view illustrating an arrangement relationship between the filter assembly and the base frame and the bottom surface of the filtration tank in FIG. 2.

FIG. 4 is a view of FIG. 2 from the top.

FIG. 5 is a view illustrating a state in which the filtration tank is removed from FIG. 2.

FIG. 6 is a view illustrating a state in which one filter assembly of a plurality of filter assemblies is separated from a base frame in a non-powered water supply system according to one embodiment of the present invention.

FIG. 7 is a view of a filter assembly applied to a non-powered water supply system according to one embodiment of the present invention viewed from the bottom.

FIG. 8 is a view illustrating a filter module constituting a filter assembly in a non-powered water supply system according to one embodiment of the present invention.

### DETAILED DESCRIPTION OF THE EMBODIMENTS

Hereinafter, embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

The non-powered water supply system 1000 according to one embodiment of the present invention may be installed in islands and mountainous areas, and may produce filtered water in which foreign substances are filtered by using a pressure difference due to the position head without a separate power, and then supply the filtered water produced to a place of use.

In addition, the non-powered water supply system 1000 according to one embodiment of the present invention does not require a separate pretreatment facility for pressing raw water, and a filter assembly 220 thereof may be individually detached and easily cleaned.

Through this, the non-powered water supply system 1000 according to one embodiment of the present invention may be easily operated and maintained and reduce production costs.

In addition, the non-powered water supply system 1000 according to one embodiment of the present invention may be implemented as a small-scale water supply facility, and may be installed in connection with existing facilities.

Accordingly, the non-powered water supply system 1000 according to one embodiment of the present invention may secure the stability of water quality even if the structure and process of the existing small-scale water supply system are not changed to prevent water quality accidents that may occur in a place of use.

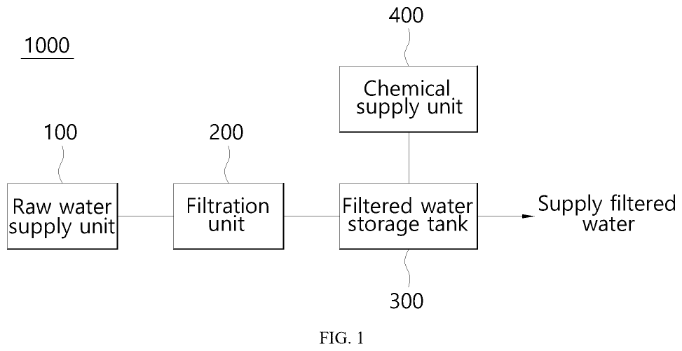

To this end, the non-powered water supply system 1000 according to one embodiment of the present invention may include a raw water supply unit 100, a filtration unit 200, and a filtered water storage tank 300 as shown in FIG. 1.

The raw water supply unit 100 may supply raw water for producing filtered water to the filtration unit 200.

In this case, the raw water supply unit 100 may supply raw water to the filtration unit 200 using a pressure difference due to the position head. That is, the raw water supply unit 100 may supply raw water to be filtered by the filtration unit 200 to the filtration unit 200 by gravity.

To this end, the raw water supply unit 100 may be installed at a higher altitude than the filtration unit 200. For example, the raw water supply unit 100 may be installed in the middle of a mountain, and the filtration unit 200 may be installed at the foot of a mountain.

Accordingly, in the non-powered water supply system 1000 according to one embodiment of the present invention, raw water of the raw water supply unit 100 may be smoothly supplied to the filtration unit 200 by using position energy due to gravity or a pressure difference due to the position head.

However, the installation location of the raw water supply unit 100 and the filtration unit 200 is not limited to this, and if the raw water supply unit 100 is installed at a higher altitude than the filtration unit 200, it may be appropriately changed depending on the installation location.

Here, raw water of the raw water supply unit 100 may be groundwater, but may be surface water such as valley water or rainwater, and the surface water may be supplied to the filtration unit while being stored in a separate supply tank (not shown) in a certain amount or may be supplied directly to the filtration unit through a supply pipe without a separate supply tank.

As a non-limiting example, the raw water supply unit 100 may be a rainwater storage tank in which a certain amount of rainwater is stored. Alternatively, the raw water supply unit 100 may be a water intake basin in which a certain amount of valley water is temporarily retained.

However, the raw water supply unit 100 is not limited to this, and if the raw water can be smoothly provided to the filtration unit 200 by using a pressure difference due to the position head, all various known methods can be applied.

The filtration unit 200 may filter raw water provided from the raw water supply unit 100 to produce filtered water.

That is, the filtration unit 200 may produce filtered water by filtering raw water supplied from the raw water supply unit 100 using water pressure caused by gravity or potential energy while a filter assembly 220 is immersed in the raw water.

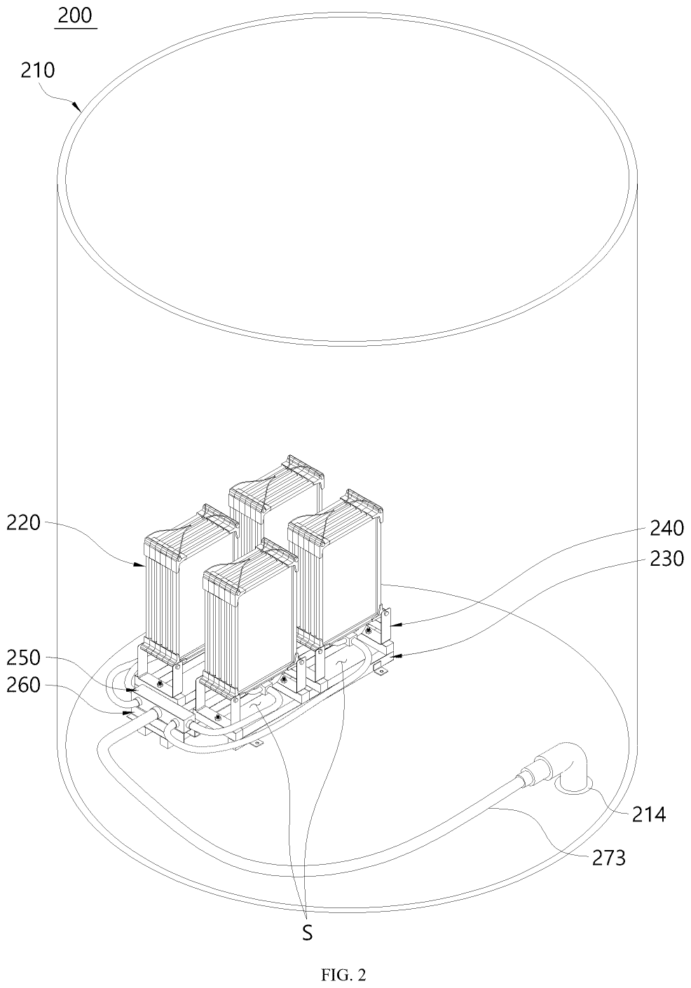

To this end, the filtration unit 200 includes a filtration tank 210, a filter assembly 220, and a base frame 230, as shown in FIGS. 2 to 4.

The filtration tank 210 may be a storage tank that stores a predetermined amount of raw water supplied from the raw water supply unit 100, the filter assembly 220 may be installed inside the filtration tank 210 to produce filtered water by filtering foreign substances from raw water stored in the filtration tank 210, and the base frame 230 may be fixedly installed on the bottom surface of the filtration tank 210 so that the filter assembly 220 may be installed in a state spaced apart from the bottom surface 212 of the filtration tank 210 by a predetermined height.

That is, one side of the filter assembly 220 may be fixed to the base frame 230, and may be disposed inside the filtration tank 210 to maintain a state of being immersed in raw water stored in a certain amount inside the filtration tank 210.

Accordingly, raw water stored in the filtration tank 210 may be converted into filtered water by filtering foreign substances through the filter assembly 220.

In this case, the filter assembly 220 may produce the filtered water using the pressure by the position head of the raw water stored in the filtration tank 210 and may be configured in a modular form to be detachably coupled to the base frame 230.

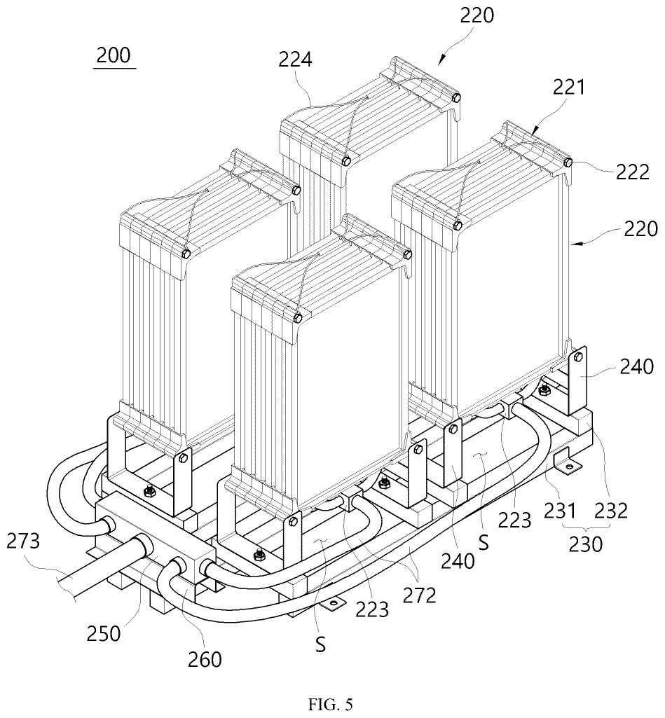

For example, as shown in FIGS. 5 to 7, the filter assembly 220 may include a plurality of filter modules 221 each including a plate-shaped filtration member 221a having a predetermined area; a fastening bar 222 for fastening the plurality of filter modules 221 together so that the filtration members 221a of each of the two adjacent filter modules 221 face each other and maintain a state spaced apart at a predetermined interval; and a common water receiving member 223 connected to a receiving port 221b provided in each of the plurality of filter modules 221 to integrate filtered water produced by each of the plurality of filter modules 221.

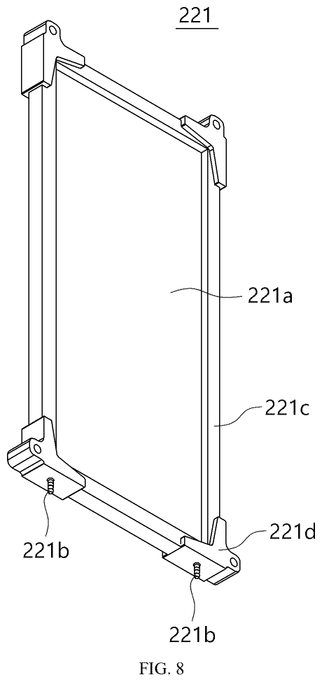

In addition, as shown in FIG. 8, each of the plurality of filter modules 221 may include a filtration member 221a having a predetermined area; an edge member 221c coupled to the edge side of the filtration member 221a; a gap maintaining member 221d coupled to the edge member 221c; and a receiving port 221b for discharging filtered water produced from the filtration member 221a to the outside.

Here, the filtration member 221a is formed in a plate shape and may produce filtered water by filtering foreign substances while the raw water passes through it, and the edge member 221c may have a flow path formed therein to allow the filtered water produced from the filtration member 221a to move while maintaining the filtration member 221a in a plate shape. In addition, the receiving port 221b may be provided in the filter module 221 to communicate with the flow path formed in the edge member 221c.

In addition, the gap maintaining member 221d may be provided to have a width wider than the width of the edge member 221c to be coupled to the edge side of the edge member 221c, and the receiving port 221b may be provided in the filter module 221 to be located on the side of the gap maintaining member 221d. In this case, the fastening bar 222 may be fastened to the gap maintaining member 221d.

Furthermore, the receiving port 221b provided in each of the plurality of filter modules 221 may be interconnected with the common water receiving member 223 through a first connection pipe 271, and the common water receiving member 223 may be disposed to be located below the filter module 221 so that filtered water produced by each filter module 221 may be smoothly introduced therein. In this case, the common water receiving member 223 may be connected to an integrated water receiving member 250 to be described later via a second connection pipe 272.

Accordingly, the plurality of filter modules 221 may be integrated through one fastening bar 222 having a predetermined length while arranged parallel to each other, and the plurality of filter modules 221 integrated through the fastening bar 222 may secure a predetermined space between adjacent filtration members 221a through the gap maintaining member 221d.

Through this, raw water present around the filtration member 221a may move to the inside of the filtration member 221a through water pressure caused by gravity or potential energy, and the raw water may be converted into filtered water by filtering foreign substances while passing through the filtration member 221a. Then, the filtered water produced by each of the plurality of filter modules 221 may be collected by the common water receiving member 223 and then moved toward the integrated water receiving member 250.

Meanwhile, the filter assembly 220 may be installed in the filtration tank 210 so that the plurality of filter modules 221 integrated through the fastening bar 222 maintain a state spaced apart from the base frame 230 at a predetermined height.

That is, the filter assembly 220 may be detachably coupled to the base frame 230 via a spacing member 240 having a predetermined height.

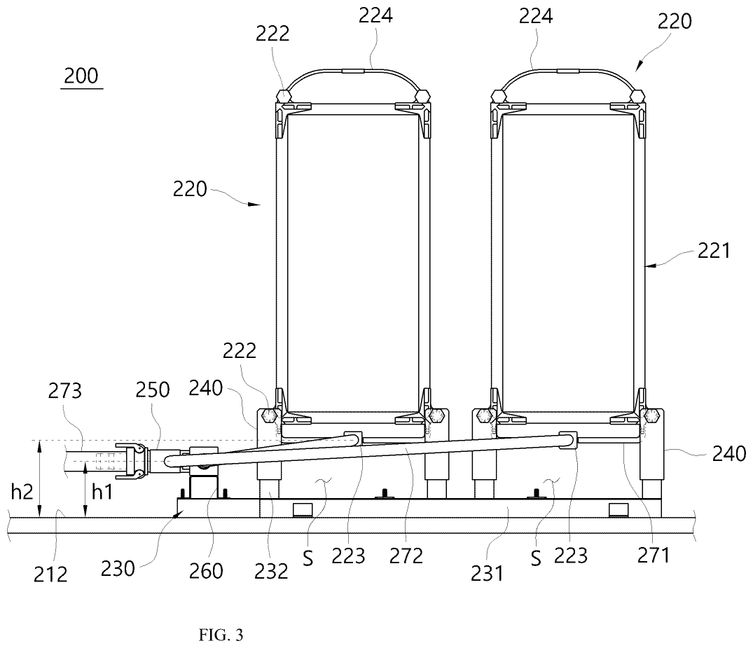

Accordingly, the filter assembly 220 may be installed inside the filtration tank 210 to maintain a certain height spaced apart from the bottom surface 212 of the filtration tank 210 and the base frame 230 via the spacing member 240, as shown in FIG. 3, and may be disposed in a state immersed in raw water filled in the filtration tank 210.

In other words, in the non-powered water supply system 1000 according to one embodiment of the present invention, when raw water stored in the filtration tank 210 is more than a certain amount, the filter assembly 220 may maintain a state completely immersed in the raw water, and the filter assembly 220 may always maintain a certain height spaced apart from the bottom surface 212 of the filtration tank 210 through the spacing member 240.

Furthermore, the filter assembly 220 is coupled to the base frame 230 installed on the bottom surface 212 of the filtration tank 210 through the spacing member 240 to prevent floating due to buoyancy, thereby maintaining a state completely immersed in raw water inside the filtration tank 210.

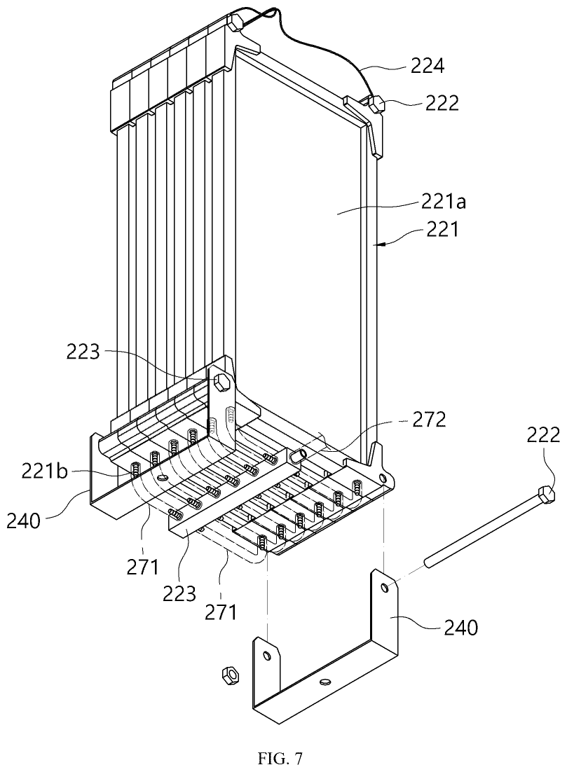

To this end, as shown in FIG. 7, the spacing member 240 may be a U-shaped frame with one side open, may be fastened to the filter assembly 220 through the fastening bar 222, and one side of the spacing member 240 may be detachably coupled to the base frame 230 through a separate fixing member.

Accordingly, the filter assembly 220 fixed to the base frame 230 via the spacing member 240 may maintain a certain height spaced apart from the bottom surface 212 of the filtration tank 210.

Through this, as shown in FIGS. 2 and 3, a foreign substance deposit space S may be formed between the filter assembly 220 and the bottom surface of the filtration tank 210, and the foreign substance deposit space S may provide a space in which foreign substances separated from raw water are deposited in the process of producing filtered water from the raw water.

That is, in the non-powered water supply system 1000 according to one embodiment of the present invention, since the foreign substance deposit space S is formed between the filter assembly 220 and the bottom surface of the filtration tank 210 through the spacing member 240, the foreign substances contained in raw water may be separated from the raw water in the process of passing through the filtration member 221a and then settled by its own weight to be deposited in the foreign substance deposit space S.

Due to this, the filtration member 221a included in each filter module 221 constituting the filter assembly 220 may fundamentally prevent the possibility of contacting foreign substances accumulated in the foreign substance deposit space S after being separated from the raw water, thereby preventing contamination by foreign substances separated from the raw water.

Through this, the non-powered water supply system 1000 according to one embodiment of the present invention may minimize contact between foreign substances separated from raw water and the filtration member 221a for producing filtered water from the raw water, thereby easily performing maintenance by reducing the washing cycle of the filtration member 221a, and securing the stability of water quality.

As described above, the base frame 230 may be fixedly installed on the bottom surface 212 of the filtration tank 210, and may maintain the filter assembly 220 at a predetermined interval spaced apart from the bottom surface 212 of the filtration tank 210.

To this end, the base frame 230 may include a plurality of first frames 231 having a predetermined length and spaced apart from each other, and a second frame 232 for mutually fastening at least two first frames 231 of the plurality of first frames 231.

In this case, the second frame 232 may be disposed to be located above the first frame 231, and the filter assembly 220 may be detachably coupled to the second frame 232 via the spacing member 240.

Accordingly, the filter assembly 220 may be coupled to the base frame 230 and installed inside the filtration tank 210 in a state spaced apart from the bottom surface 212 of the filtration tank 210 by a predetermined interval.

In this case, the non-powered water supply system 1000 according to one embodiment of the present invention may include a plurality of filter assemblies 220 coupled to the base frame 230, and each of the plurality of filter assemblies 220 may be detachably coupled to the base frame 230.

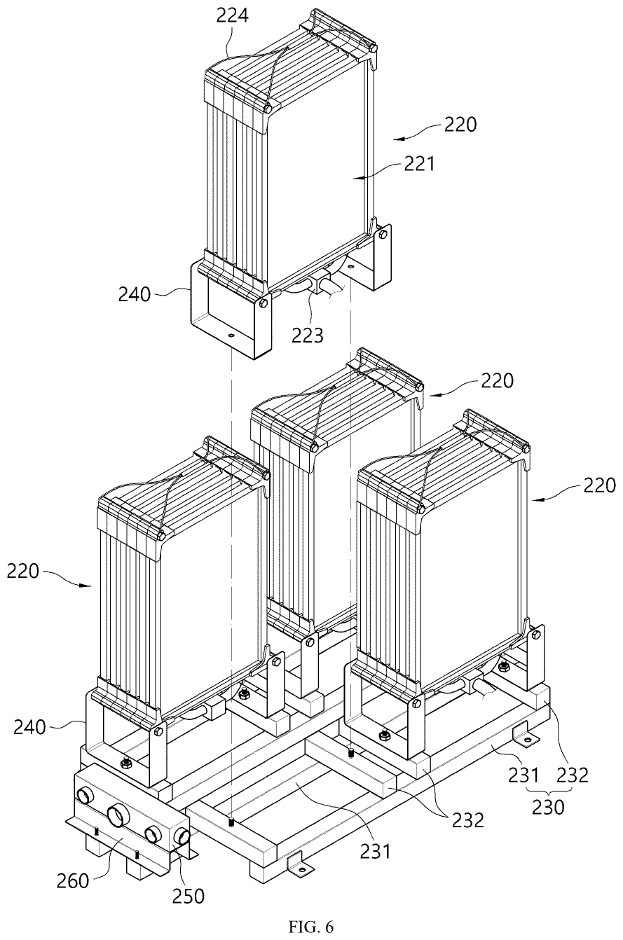

That is, as shown in FIGS. 5 and 6, each of the plurality of filter assemblies 220 may be detachably coupled to the base frame 230, respectively, via the spacing member 240.

In this case, the non-powered water supply system 1000 according to one embodiment of the present invention may further include an integrated water receiving member 250 connected to the common water receiving member 223 provided in each of the plurality of filter assemblies 220 via a second connection pipe 272 to integrate filtered water produced in each of the plurality of filter assemblies 220.

In addition, each of the plurality of filter assemblies 220 may further include a towing wire 224 with both ends fixed respectively to two fastening bars 222 for integrating the plurality of filter modules 221.

Accordingly, an operator can individually couple any one filter assembly 220 of the plurality of filter assemblies 220 to the base frame 230 or separate it from the base frame 230, and can easily separate or couple each filter assembly 220 from/to the base frame 230 using the towing wire 224.

Due to this, the non-powered water supply system 1000 according to one embodiment of the present invention may selectively separate any one filter assembly 220 of the plurality of filter assemblies 220 connected respectively to the integrated water receiving member 250 while being fixed to the base frame 230, respectively.

Accordingly, in the non-powered water supply system 1000 according to one embodiment of the present invention, it is possible to easily replace any one filter assembly 220 selected from the plurality of filter assemblies 220 while continuously producing filtered water without stopping the production of the entire filtered water.

Through this, the non-powered water supply system 1000 according to one embodiment of the present invention may continuously supply filtered water to a place of use without stopping the entire process even during maintenance.

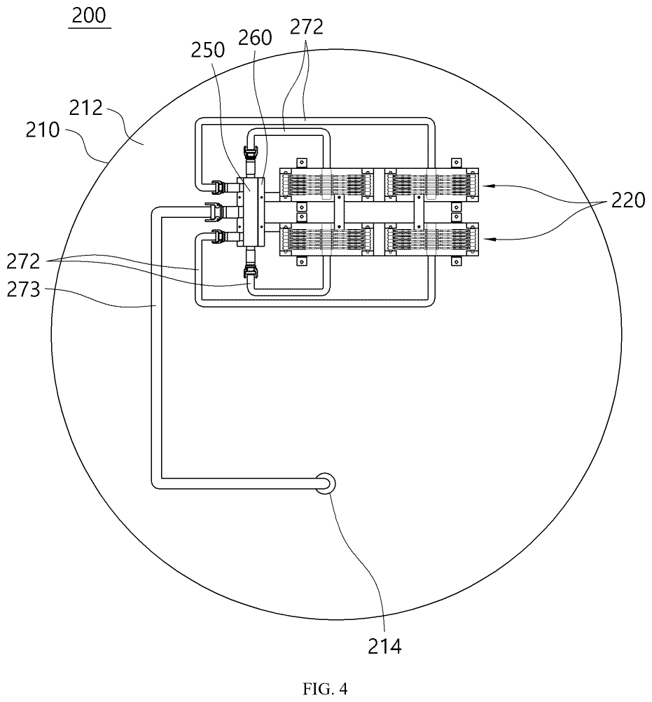

Here, as shown in FIG. 4, the integrated water receiving member 250 may be connected on a one-to-one basis to the common water receiving member 223 provided in each of the plurality of filter assemblies 220 via a second connection pipe 272, and both ends of the second connection pipe 272 may be detachably connected to the common water receiving member 223 and the integrated water receiving member 250. In this case, as shown in FIGS. 2 and 4, the integrated water receiving member 250 may be connected to an outlet 214 formed on the bottom surface 212 of the filtration tank 210 through a discharge pipe 273. In addition, the integrated water receiving member 250 may be fixed to the base frame 230 via a coupling frame 260.

Accordingly, filtered water produced by each of the plurality of filter assemblies 220 may move to the integrated water receiving member 250 through each common water receiving member 223, and the filtered water moved to the integrated water receiving member 250 may move toward the outlet 214 through the discharge pipe 273.

In this case, the integrated water receiving member 250 may be installed in the filtration tank 210 to be located at a lower position than the common water receiving member 223 provided in each filter assembly 220.

For example, the integrated water receiving member 250 may be coupled to the base frame 230 to be located at a lower position than the common water receiving member 223.

That is, as shown in FIG. 3, the integrated water receiving member 250 may be coupled to the base frame 230 to be located higher from the bottom surface 212 of the filtration tank 210 than the common water receiving member 223.

Accordingly, in the non-powered water supply system 1000 according to one embodiment of the present invention, the filtered water produced by the filtration member 221a using the pressure by the position head may move toward the integrated water receiving member 250 through the common water receiving member 223 even if no separate power is used.

The filtered water storage tank 300 may temporarily store a predetermined amount of filtered water produced by the filtration unit 200. That is, the filtered water storage tank 300 may be connected to the outlet 214 provided in the filtration tank 210, and may receive filtered water from the outlet 214 to store a certain amount of filtered water therein.

For example, the filtered water storage tank 300 may be a storage tank having an internal space, and the filtered water stored in the filtered water storage tank 300 may be supplied to a place of use.

Accordingly, a user may use the filtered water supplied from the filtered water storage tank 300 as a water supply.

In the drawings and descriptions, although it is illustrated and descripted that the filtered water produced by the filtration unit 200 is stored in the filtered water storage tank 300 and then supplied to a place of use, the present invention is not limited thereto, and the filtered water produced by the filtration unit 200 may be directly supplied to a place of use without being stored in the filtered water storage tank 300.

Furthermore, the filtered water storage tank 300 may be provided separately from the filtration unit 200, or may be integrally formed with the filtration tank 210 of the filtration unit

Meanwhile, the non-powered water supply system 1000 according to one embodiment of the present invention may further include a chemical supply unit 400 for disinfecting raw water supplied to the filtration tank 210 or for disinfecting filtered water produced in the filtration tank 210.

For example, as shown in FIG. 1, the chemical supply unit 400 may be connected to the filtered water storage tank 300 to supply a certain amount of disinfectant to the filtered water stored in the filtered water storage tank 300.

Here, the disinfectant may be a chlorine solution such as sodium hypochlorite solution to prevent contamination of filtered water supplied to a place of use and to inactivate waterborne pathogens that can cause diseases in the human body.

Accordingly, a user may use a water supply having secured stability from waterborne pathogens including viruses.

In the drawings and descriptions, although it is illustrated and descripted that the chemical supply unit 400 is supplied to the filtered water storage tank 300, the present invention is not limited thereto, and the chemical supply unit 400 may be configured to supply the disinfectant to the filtration tank 210 of the filtration unit 200 or to a connection pipe connecting the raw water supply unit 100 and the filtration unit 200.

Meanwhile, in the non-powered water supply system 1000 according to one embodiment of the present invention, the filtration member 221a may produce filtered water by filtering foreign substances contained in raw water as described above.

For example, the filtration member 221a may be a filtration member that can maintain turbidity at 0.1 NTU or less, filter bacteria or protozoa or the like smoothly, and have a filtration performance of 0.35 m³/m²·d or more.

Such a filtration member 221a may be a single-layered filtration member, but may be a multi-layered filtration member.

As a non-limiting example, the filtration member 221a may have a plate shape in which one or more layers of nanofiber webs (not shown) are stacked on one surface or both surfaces of a support body (not shown) formed of a porous substrate. In this case, the nanofiber web may serve as a filter paper to filter out foreign substances contained in the raw water while the raw water passes, and the support body may serve as a moving passage for moving filtered water produced by the nanofiber web while supporting the nanofiber web.

However, the configuration of the filtration member 221a is not limited to this, and all known filtration members commonly used for water treatment can be applied.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

What is claimed is:

1. A non-powered water supply system, comprising:
a raw water supply unit configured to supply raw water;
a filtration unit, comprising; a filtration tank for storing a predetermined amount of the raw water supplied from the raw water supply unit, a filter assembly installed inside the filtration tank to produce filtered water by filtering out foreign substances from the raw water, and a base frame fixed to a bottom surface of the filtration tank so that the filter assembly is allowed to be installed at a first predetermined height above the bottom surface of the filtration tank; and
a filtered water storage tank for temporarily storing the filtered water produced in the filtration tank.

2. The non-powered water supply system of claim 1, wherein the raw water is valley water, or rainwater stored in a rainwater storage tank.

3. The non-powered water supply system of claim 1, wherein the raw water supply unit is located at a higher altitude than the filtration unit so that the raw water is supplied to the filtration tank by gravity.

4. The non-powered water supply system of claim 1, further comprising a chemical supply unit for disinfecting the raw water supplied to the filtration tank or for disinfecting the filtered water produced in the filtration tank.

5. The non-powered water supply system of claim 1, wherein the filter assembly comprises:
a plurality of filter modules each comprising a plate-shaped filtration member having a predetermined area;
a fastening bar configured to fasten the plurality of filter modules together so that the plate-shaped filtration members of each two adjacent filter modules of the plurality of filter modules face each other and maintain a state spaced apart at a predetermined interval; and
a common water receiving member connected to a receiving port provided in each of the plurality of filter modules to integrate filtered water produced by each of the plurality of filter modules;
wherein the filter assembly is detachably coupled to the base frame via a spacing member so that the plurality of filter modules integrated through the fastening bar are installed at a second predetermined height spaced apart from the base frame.

6. The non-powered water supply system of claim 5, wherein the base frame comprises a plurality of first frames having a predetermined length and spaced apart from each other, and a second frame configured to fasten mutually at least two first frames of the plurality of first frames, and
wherein the filter assembly is detachably coupled to the second frame via the spacing member.

7. The non-powered water supply system of claim 6, further comprising a plurality of filter assemblies detachably coupled to the base frame and an integrated water receiving member connected to the common water receiving member provided in each of the plurality of filter assemblies to integrate the filtered water produced in each of the plurality of filter assemblies,
wherein the integrated water receiving member is coupled to the base frame to be located at a lower position than the common water receiving member.

8. The non-powered water supply system of claim 5, wherein the filter assembly further comprises a towing wire with both ends fixed respectively to two fastening bars for integrating the plurality of filter modules.
